(19) United States
(12) Patent Application Publication
(10) Pub. No.: US 2017/0140334 A1
(43) Pub. Date: May 18, 2017

(54) Apparatus To Provide A 3-D Simulation-Experience For a Non-Point-of-Sale Logistics and Supply Chain Challenge

(71) Applicant: Wal-Mart Stores, Inc., Bentonville, AR (US)

(72) Inventors: Donald R. High, Noel, MO (US); Chandrashekar Natarajan, San Ramon, CA (US); Dhaval Gat, Bangalore (IN)

(21) Appl. No.: 15/353,316

(22) Filed: Nov. 16, 2016

Related U.S. Application Data
(60) Provisional application No. 62/257,167, filed on Nov. 18, 2015.

(51) Int. Cl. G06Q 10/08; G06F 3/00; G06F 3/0481; G06F 3/16; G06F 3/01

(52) U.S. Cl. CPC G06Q 10/087; G06F 3/167; G06F 3/011; G06F 3/017; G06F 3/04815; G06F 3/005

(57) ABSTRACT

A memory stores a plurality of selected non-point-of-sale (POS) retail sales logistics and supply chain locales and a virtual reality visual interface provides a three-dimensional simulation experience using those locales. At least one camera in the three-dimensional simulation-experience area provides images of a user experiencing the simulation and at least one microphone receives verbalized input from the user during such an experience. By one approach, a computer operably couples to the foregoing elements and serves to present these user with at least one retail sales non-POS logistics and supply chain challenge that features a selected one of the non-POS retail sales logistics and supply chain locales. That computer then monitors the user's response to the challenge via at least the camera and the microphone and advances the simulation experience based upon the user's responses by selectively presenting at least one additional retail sales non-POS logistics and supply chain challenge.

### CROSS-REFERENCE TO RELATED APPLICATIONS

This application claims the benefit of U.S. Provisional Application No. 62/257,167, filed Nov. 18, 2015, and is incorporated herein by reference in its entirety.

### TECHNICAL FIELD

These teachings relate generally to virtual reality.

### BACKGROUND

Mercantile logistics and supply chains comprise a long-standing area of prior art practice, stemming back to the Silk Road trade route and beyond. Notwithstanding that long history of activity, however, retail sales logistics and supply chains are anything but a static paradigm. Instead, retail sales opportunities and approaches continue to evolve (owing in no small part to technological advances) and supply chain alternatives continue to develop in ways that result in an ever-growing number of alternatives that each have their own corresponding costs and benefits.

In addition, customer expectations continually change and typically expand as well. For example, time of delivery and place of delivery expectations have continued to change in challenging ways. Customer expectations regarding what kinds of goods can and should be readily available have also grown in challenging ways.

A modern retailer accordingly faces numerous challenges in meeting such expectations. As one example in these regards, it can be both time-consuming and costly to suitably test and vet a variety of available or soon to be available retail sales logistics and supply chain approaches, either in general or with respect to a particular product line. As another example in these regards, it can be similarly difficult to test currently unavailable approaches in these regards as part of exploring or inventing, for example, new delivery paradigms.

In addition, the speed at which the relevant landscape is changing exacerbates the foregoing problems. For example, managers who came up through the ranks and therefore had prior working experience with previous retail sales logistics and supply chain experiences are not necessarily always able to reliably leverage that experience when making decisions regarding new opportunities in these regards.

### BRIEF DESCRIPTION OF THE DRAWINGS

The above needs are at least partially met through provision of an apparatus to provide a 3-D simulation-experience for a non-point-of-sale logistics and supply chain challenge described in the following detailed description, particularly when studied in conjunction with the drawings, wherein:

FIG. 1 comprises a flow diagram as configured in accordance with various embodiments of these teachings; and

FIG. 2 comprises a block diagram as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, an apparatus can include a memory having stored therein a plurality of selected non-point-of-sale (POS) retail sales logistics and supply chain locales, a virtual reality visual interface configured and arranged to provide in a three-dimensional simulation-experience area a three-dimensional view of any of the plurality of selected retail sales logistics and supply chain locales, at least one camera in the three-dimensional simulation-experience area configured to provide images of a user experiencing a retail sales logistics and supply chain simulation experience, and at least one microphone in the three-dimensional simulation-experience area configured to receive verbalized input from the user during such an experience.

By one approach, a computer operably couples to the foregoing elements and serves to present these user with at least one retail sales non-POS logistics and supply chain challenge via a retail sales logistics and supply chain simulation experience that features a selected one of the non-POS retail sales logistics and supply chain locales. That computer then monitors the user's response to the challenge via at least the camera and the microphone and advances the simulation experience based upon the user's responses by selectively presenting at least one additional retail sales non-POS logistics and supply chain challenge.

Such an apparatus can permit a user to train with respect to a variety of retail sales logistics and/or supply chain opportunities. In particular, such a user can learn through experience which opportunities in these regards are particularly salient given a particular set of circumstances. Such an apparatus can also permit a user to test a new presently-unavailable approach in these regards with respect to one or more evaluation criteria as desired.

These teachings are highly flexible in practice and will accommodate a variety of variations and modifications. The aforementioned non-POS retail sales logistics and supply chain locales, for example, can include one or more of a loading dock, a delivery vehicle interior, a retail product storeroom, an off-site customer delivery locale, an order-taking station, and so forth as desired. The aforementioned retail sales logistics and supply chain simulation experience, in turn, can comprise one or more of a home grocery delivery scenario, an order fulfillment shipment from a retail store to a customer's address scenario, a single-day order fulfillment shipment to a customer's address scenario, an order fulfillment shipment to a retail store for customer pickup scenario, a delivery to a customer's address using an airborne or terrestrial drone scenario, and so forth as desired.

By one approach the aforementioned non-POS logistics and supply chain challenge can comprise an order fulfillment decision point having at least two differing logistics and supply chain decision possibilities.

By one approach the user's response to the challenge must comprise, at least in part, a physical motion by the user corresponding to a virtual (and/or real) interaction with something presented in the retail sales logistics and supply chain simulation experience. For example, by one approach that physical motion must correspond to a particular retail sales logistics and supply chain-based task. By one approach the retail sales logistics and supply chain simulation experience includes at least one physical prop. In such a case the retail sales non-POS logistics and supply chain challenge can include, at least in part, physical manipulation of that physical prop by the user.

So configured, the user can experience a variety of modern retail sales logistics and supply chain alternatives, results, and experiences in a rapid yet easily learned manner. These teachings can therefore greatly assist various associates of the retail enterprise, from entry-level to senior management, to develop and/or maintain proficiency with respect to this important area of endeavor.

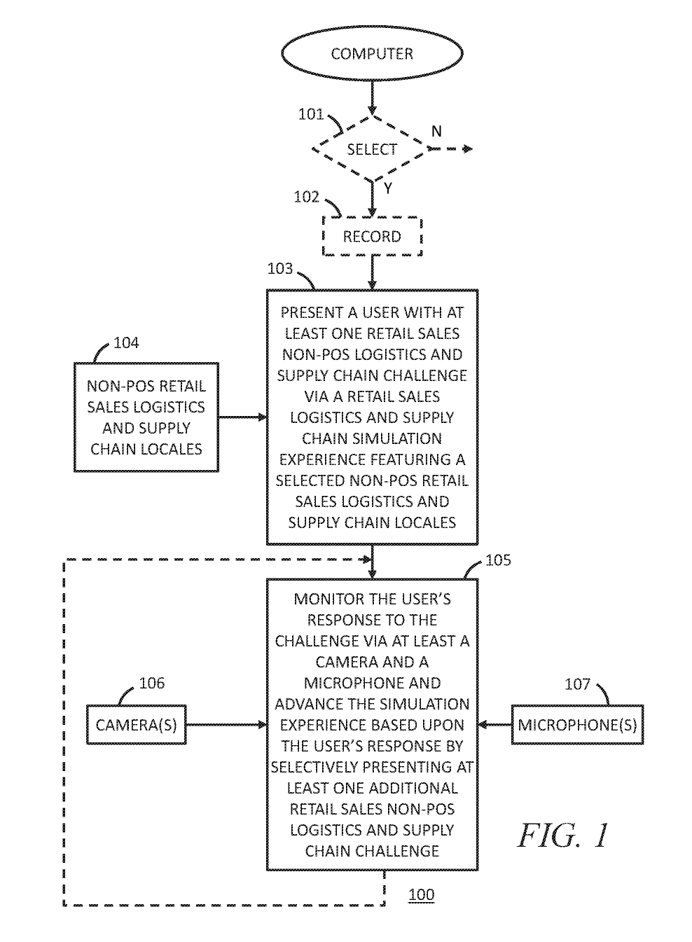

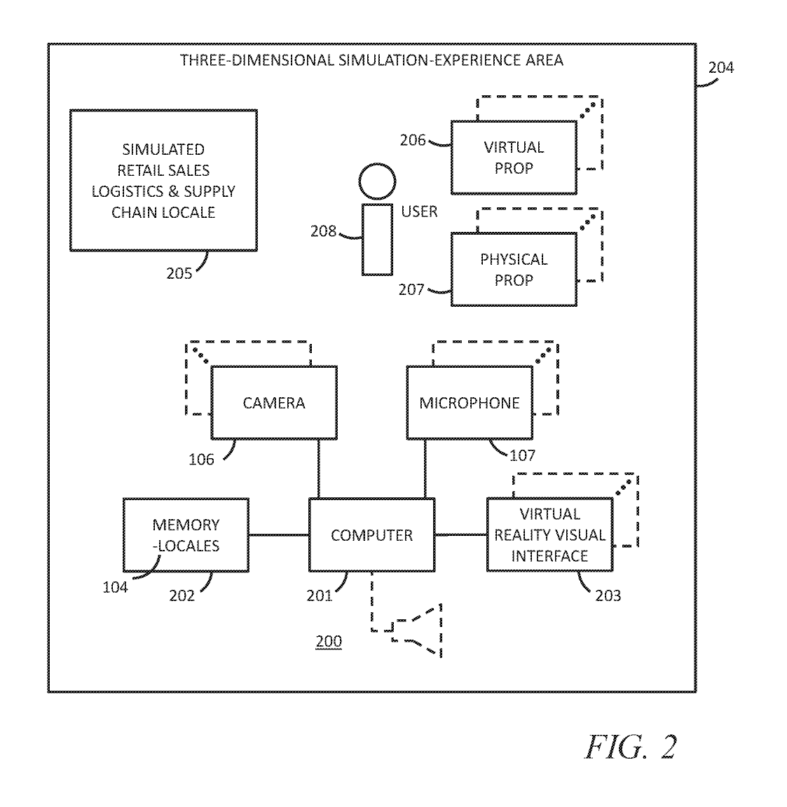

These and other benefits may become clearer upon making a thorough review and study of the following detailed description. Referring now to the drawings, and in particular to FIG. 1, an illustrative process 100 that is compatible with many of these teachings will now be presented. For the sake of an illustrative example, it will be presumed in this description that a computer of choice carries out the described process 100. It will further be presumed that this process 100 is carried out in conjunction with an appropriately configured three-dimensional simulation-experience area. FIG. 2 presents an illustrative example in these regards.

In this illustrative example the apparatus 200 includes a computer 201 that operably couples to a memory 202. The computer 201 constitutes a control circuit. Being a “circuit,” the control circuit therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit is configured (for example, by using corresponding programming as will be well understood by those skilled in the art) to carry out one or more of the steps, actions, and/or functions described herein.

In this illustrative example the computer 201 operably couples to a memory 202. This memory 202 may be integral to the aforementioned control circuit or can be physically discrete (in whole or in part) from the control circuit as desired. This memory 202 can also be local with respect to the control circuit (where, for example, both share a common circuit board, chassis, power supply, and/or housing) or can be partially or wholly remote with respect to the control circuit (where, for example, the memory 202 is physically located in another facility, metropolitan area, or even country as compared to the control circuit).

In addition to storing other information as described herein, this memory 202 can serve, for example, to non-transitorily store the computer instructions that, when executed by the computer 201, cause the computer 201 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

The computer 201 also operably couples to a virtual reality visual interface 203. This virtual reality visual interface can comprise, for example, a three-dimensional projector or a head-worn three-dimensional display, both of these components being known and well understood in the art. This virtual reality visual interface 203 provides a three-dimensional view within a corresponding three-dimensional simulation experience area 204.

The three-dimensional simulation-experience area 204 can comprise, for example, a part of or all of a given room in a building. By one approach the walls and other surfaces of this area 204 are blank in visual appearance and may be lightly colored in order to provide a neutral surface upon which the three-dimensional view can be presented. By another approach, in lieu of the foregoing or in combination therewith, the three-dimensional simulation-experience area 204 may include one or more physical surfaces, other than mere walls, floors, and ceilings, upon which such images can be presented or which can otherwise figure into the presentation.

By one approach the aforementioned memory 202 can have stored therein the data corresponding to a plurality of selected non-point-of-sale (POS) retail sales logistics and supply chain locales 104. These teachings are highly flexible in these regards and will accommodate a wide variety of such locales. Examples include but are not limited to a loading dock, a delivery vehicle interior, a retail product storeroom, an off-site customer delivery locale, an order taking station, and so forth. By one approach, for example, the memory 202 can include at least three such locales.

So configured, the aforementioned virtual reality visual interface 203 can access the data regarding a particular such locale 104 and use that data to present in the three-dimensional simulation-experience area 204 a simulated retail sales logistics and supply chain locales 205. Generally speaking, the creation and presentation of a particular simulated locale as a three-dimensional experience comprises a known area of endeavor. As the present teachings are not overly sensitive to any particular choices in these regards, further elaboration with respect to such a presentation is not provided here for the sake of brevity.

By one approach the virtual reality visual interface 203 can further present one or more virtual props 206 in the three-dimensional simulation-experience area 204. Typically, these virtual props 206 will be appropriate to the particular retail sales logistics and supply chain locale being presently simulated. Examples of props include but are certainly not limited to one or more retail products, packages, vehicles (including trucks and trailers, terrestrial and airborne drones, forklifts, and pallet movers, to note but a few examples in these regards), communications devices, computers and computer interfaces, and so forth.

By another approach, in lieu of the foregoing or in combination therewith, the three-dimensional simulation-experience area 204 can also include one or more physical props 207. In this case, it will be understood that a “prop” constitutes an object that is inherently portable during ordinary use. Accordingly, a package, dolly, or vehicle can be a prop while a desk or shelf is not a prop because desks and shelves are not ordinarily moved during ordinary use. That said, a drawer in a desk could serve as a prop since a drawer is designed and intended to be moved during ordinary use. In a typical application setting the physical props 207 will again be appropriate to the particular retail sales logistics and supply chain locale being presently simulated (which is to say that the prop will be a natural item to find in such a locale).

If desired, the computer 200 and/or the virtual reality visual interface 203 can also operably couple to an optional audio system 209. So configured, audible sounds that are appropriate to the simulated retail sales logistics and supply chain locale 205 can be provided to thereby further enhance the simulated experience. The sound source itself can be monophonic, stereophonic, or otherwise as desired. By one approach the sound source can be an open air system or can comprise, for example, headphones or the like that are worn by a user.

In this illustrative example the computer 201 also operably couples to one or more cameras 106 (such as but not limited to a video camera) and one or more microphones 107 that are arranged and deployed in the three-dimensional simulation-experience area 204 or which are mounted and arranged to otherwise capture content from that area 204 (where, for example, a video camera is mounted outside the area 204 behind a window to permit the video camera to capture images from within the area 204). So configured, the computer 201 can receive information regarding, for example, the verbal responses and/or physical responses of a user in the three-dimensional simulation-experience area 204. These teachings will accommodate other sensors in the same regards, such as proximity sensors, distance-measurement sensors, accelerometers, pressure sensors, and so forth as desired.

So configured, a user 208 in the three-dimensional simulation-experience area 204 can see and otherwise “experience” the simulated retail sales logistics and supply chain locale 205 and whatever virtual or physical props 206 and 207 may be arranged therein.

With continued reference to both FIGS. 1 and 2, at optional block 101 a user can be provided with an opportunity to make a selection (or selections) as pertain to one or more variables regarding a three-dimensional simulation experience. For example, when a plurality of different retail sales logistics and supply chain simulation experiences are available, the user can select a particular one of these experiences. As another example, the user might be able to select a particular level of difficulty as pertains to a particular retail sales logistics and supply chain simulation experience or some other parameter settings such as a geographic location for the experience, a time of year or time of day for the experience, a particular setting regarding the relative availability of one or more items in inventory or a distribution chain, a particular customer personality or demographic type, and so forth. So configured, a user can select a particular experience in order to achieve a particular training, evaluation, or vetting goal.

In the absence of detecting any such selections this process 100 can accommodate any of a variety of responses. By one approach the computer 201 can proceed with the process 100 using a default or otherwise automatically selected setting or settings. By another approach the computer 201 can continue to at least occasionally monitor for one or more selections in these regards.

At optional block 102 a user can select to record the retail sales logistics and supply chain simulation experience that they are about to conduct. Or conversely the user can elect to not record the experience. Or, in lieu of the foregoing or in combination therewith, the user can make one or more selections as regards such a recording. Examples in these regards include selecting a particular video resolution, whether to record all or only part of the experience, setting access limits with respect to who can later review the recording or otherwise interact with that recording, and so forth. When a recording has been made of a given retail sales logistics and supply chain simulation experience the aforementioned computer 201 can be configured to subsequently process that recording (for example, by playing back the recording and/or editing that recording per the inputs and selections of a user).

At block 103 this process 100 provides for presenting a user 208 with at least one retail sales non-POS logistics and supply chain challenge via the aforementioned retail sales logistics and supply chain experience featuring a selected one of the non-POS retail sales logistics and supply chain locales 104. These teachings will accommodate a wide variety of retail sales logistics and supply chain simulation experiences. Examples in these regards include but are certainly not limited to a home grocery delivery scenario, an order fulfillment shipment from a retail store to a customer's address scenario (such as a customer's residential address or a customer's business address), a same-day order fulfillment shipment to a customer's address scenario, an order fulfillment shipment to a retail store for customer pickup scenario, a delivery to a customer's address using an airborne or terrestrial drone scenario, and so forth.

By one approach, the computer 201 presents the user with the retail sales non-POS logistics and supply chain challenge by presenting an order fulfillment decision point having at least two differing logistics and supply chain decision possibilities. As one simple example in these regards, when the experience represents a same-day order fulfillment shipment to a customer's address scenario, the user may be presented with a choice between using an in-house delivery capability and a third-party delivery capability (such as a local courier service). As another simple example in these regards, the user may be presented with a choice between a manned, terrestrial vehicle-based delivery to a customer's address and an airborne drone-based delivery to a customer's address. In many cases it may be useful and appropriate to present the user with more than two such possibilities.

At block 105 the computer 201 monitors the user's response to the aforementioned challenge via at least a camera 106 and a microphone 107. By one approach the user's response to the challenge must comprise, at least in part, a physical motion by the user corresponding to a virtual interaction with something presented in the retail sales logistics and supply chain simulation experience and/or a physical motion by the user corresponding to an actual real-world interaction with a physical prop that comprises a part of the retail sales logistics and supply chain simulation experience.

These interactions can be direct or indirect with respect to the task being represented. For example, when selecting between delivering an item to a customer by a terrestrial vehicle and an airborne drone, the user may make physical motions consistent with placing a virtual representation of the item into a virtual representation of the terrestrial vehicle or the airborne drone in order to indicate the selection being made. As another example in the same regards, the user may move a physical product that represents the item towards or into a virtual representation of the terrestrial vehicle or the airborne drone in order to again indicate the selection being made.

Based upon the monitored user's response to the challenge, the computer 201 then advances the simulation experience by selectively presenting at least one additional retail sales non-POS logistics and supply chain challenge. By one approach the experience is advanced at least in part by also presenting a result that occurs based upon the user's response to the challenge. For example, the computer 201 may determine a probability of success or failure based upon real-world statistical probabilities. As an illustrative example in these regards, when selecting a particular delivery paradigm to meet the need of delivering an item to a particular customer at a particular address by or before a particular time of day, actual real-world results relevant to those conditions can be leveraged to calculate the likelihood of the selected paradigm achieving the desired results and that likelihood then being utilized to present the user with a delivery result in the context of the simulation experience.

By one approach the aforementioned statistics can represent a global aggregation of available statistics that are pertinent to the experience or action. By another approach the real-world statistical probabilities can pertain to a non-global, particular geographic venue as corresponds to the selected non-POS retail sales logistics and supply chain locale. Such an approach can help the user experience and understand that one delivery paradigm may work successfully in one geographic location (such as a large metropolitan area) but less reliably in another geographic location (such as a rural area).

By another approach the aforementioned statistics can pertain to customer demographics as correspond to the selected non-POS retail sales logistics and supply chain locale. Statistics in these regards, for example, may demonstrate and exemplify that some customers (such as customers within a particular age bracket) prefer one type of delivery paradigm over another (or, conversely, do not like one type of delivery paradigm as compared to another). Accordingly, these teachings will accommodate the real-world statistical probabilities pertaining to a likelihood of a particular order-fulfillment service being selected by a real-world customer (either in general or with respect to a particular demographically-parsed customer). By taking such demographics into account the user can develop experience and sensitivity not only with respect to whether a particular delivery paradigm achieves the basic result of getting an item to a particular address by a particular time but also whether the customer is likely pleased or unhappy with the result notwithstanding that non-time delivery.

By one approach a particular retail sales logistics and supply chain simulation experience can simply comprise a simulated retail sales logistics and supply chain locale and a corresponding retail sales non-POS logistics and supply chain challenge that comprises at least in part a particular retail sales logistics and supply chain-based task to which the user responds, at least in part, with a physical action that may include manipulating or otherwise moving or interacting with a physical prop that pertains to that simulated locale or task. By another approach such an experience can comprise a series of such challenges where a next-presented challenge depends upon the user's response to a preceding challenge.

By calculating the result and/or consequences of a user's responses to challenges as described above as a function, at least in part, of various real-world statistics in these regards, these teachings provide a powerful and intuitive approach to training (or retraining) associates at all levels of an enterprise. These teachings also provide a powerful and intuitive approach to vetting new technologies and/or processes as regards retail sales logistics and supply chains.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. An apparatus comprising:
a memory having stored therein a plurality of selected non-point of sale (POS) retail sales logistics and supply chain locales;
a virtual reality visual interface configured and arranged to provide in a three-dimensional simulation-experience area a three-dimensional view of any of the plurality of selected retail sales logistics and supply chain locales;
at least one camera in the three-dimensional simulation-experience area configured to provide images of a user experiencing a retail sales logistics and supply chain simulation experience;
at least one microphone in the three-dimensional simulation-experience area configured to receive verbalized input from the user;
a computer operably coupled to the memory, the virtual reality visual interface, the at least one microphone, and the at least one camera and configured to:
present the user with at least one retail sales non-POS logistics and supply chain challenge via a retail sales logistics and supply chain simulation experience featuring a selected one of the non-POS retail sales logistics and supply chain locales;
monitor the user's response to the challenge via at least the camera and the microphone and advance the simulation experience based upon the user's response by selectively presenting at least one additional retail sales non-POS logistics and supply chain challenge.

2. The apparatus of claim 1 wherein the plurality of selected non-point of sale (POS) retail sales logistics and supply chain locales include at least three of:
a loading dock;
a delivery vehicle interior;
a retail product storeroom;
an off-site customer delivery locale;
an order taking station.

3. The apparatus of claim 1 wherein the virtual reality visual interface comprises at least one of a three-dimensional projector and a head-worn three-dimensional display.

4. The apparatus of claim 1 wherein the camera comprises a video camera.

5. The apparatus of claim 1 wherein the retail sales logistics and supply chain simulation experience comprises one of:
a home grocery delivery scenario;
an order fulfillment shipment from a retail store to a customer's address scenario;
a same-day order fulfillment shipment to a customer's address scenario;
an order fulfillment shipment to a retail store for customer pickup scenario;
a delivery to a customer's address using an airborne drone scenario.

6. The apparatus of claim 1 wherein the at least one retail sales non-POS logistics and supply chain challenge comprises an order fulfillment decision point having at least two differing logistics and supply chain decision possibilities.

7. The apparatus of claim 1 wherein the user's response to the challenge must comprise, at least in part, a physical motion by the user corresponding to a virtual interaction with something presented in the retail sales logistics and supply chain simulation experience.

8. The apparatus of claim 7 wherein the physical motion must correspond to a particular retail sales logistics and supply chain-based task.

9. The apparatus of claim 1 wherein the computer is configured to advance the simulation experience based upon the user's response by determining a probability of success or failure based upon real-world statistical probabilities.

10. The apparatus of claim 9 wherein the real-world statistical probabilities pertain to a particular geographic venue as corresponds to the selected one of the non-POS retail sales logistics and supply chain locales.

11. The apparatus of claim 9 wherein the real-world statistical probabilities pertain to customer demographics as correspond to the selected one of the non-POS retail sales logistics and supply chain locales.

12. The apparatus of claim 9 wherein the real-world statistical probabilities pertain to a likelihood of a particular order-fulfillment service being selected by a real-world customer.

13. The apparatus of claim 1 wherein the computer is further configured to present the user with an opportunity to select the retail sales logistics and supply chain simulation experience.

14. The apparatus of claim 1 wherein the computer is further configured to record the retail sales logistics and supply chain simulation experience.

15. The apparatus of claim 14 wherein the computer is further configured to subsequently process a recording of the retail sales logistics and supply chain simulation experience.

16. The apparatus of claim 15 wherein the computer is configured to subsequently process the recording by at least one of:
playing back the recording;
editing the recording.

17. The apparatus of claim 1 further comprising:
at least one physical prop that comprises a part of the retail sales logistics and supply chain simulation experience;
and wherein the at least one retail sales non-POS logistics and supply chain challenge comprises, at least in part, physical manipulation of the physical prop by the user.
